(19) United States
(12) Patent Application Publication
(10) Pub. No.: US 2004/0185774 A1
(43) Pub. Date: Sep. 23, 2004

(54) System, device, and method for receving satellite radio on a handheld computing device

(76) Inventor: Bryan A. Scott, Plano, TX (US)

Correspondence Address: Steven Thrasher, 391 Sandhill Dr., Richardson, TX, 75080, US

(21) Appl. No.: 10/801,973

(22) Filed: Mar. 15, 2004

Related U.S. Application Data
(60) Provisional application No. 60/456,887, filed on Mar. 21, 2003.

(51) Int. Cl. H04B 7/15

(52) U.S. Cl. 455/11.1; 455/90.3

(57) ABSTRACT

The invention provides systems, methods and devices that transfer a satellite radio data-element from a device to a handheld computer.

### RELATED APPLICATION

This application is related to co-owned and co-pending U.S. Provisional Patent Application No. 60/456,887 entitled SYSTEM, DEVICE, AND METHOD FOR RECEIVING SATELLITE RADIO ON A HANDHELD COMPUTING DEVICE, to Bryan Scott, and filed on 21 Mar. 2003.

### TECHNICAL FIELD

The invention relates to portable computing.

### STATEMENT OF A PROBLEM ADDRESSED BY THE INVENTION

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

### Discussion

Each satellite radio provider encodes their radio signal differently, which can only be decoded by their own radio receiver(s). Satellite radio providers, through partnerships with radio manufacturers, sell radio receivers that allow a user to decode their own satellite radio signal, but no other radio signals. These radio receivers have been designed for use in cars, homes, boats, or in “jam boxes.” Some of these satellite radio providers even have satellite radio receivers that have been integrated within semi-portable entertainment centers.

Unfortunately, although satellite radio provides uninterrupted quality radio at a monthly subscription cost to a subscriber, each of the satellite radio receivers is limited to use within various predefined environments such as a car, a home, or a boat. In addition, each radio receiver is very expensive. Thus, it is cost prohibitive to have a separate satellite radio receiver for each environment. Accordingly, it is desirable to provide a device, system, and method for adapting a single satellite radio portable receiver to be used in multiple environments. The invention provides such devices, systems, and methods.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 depicts a satellite radio handheld computer accessory system;

FIG. 2 shows a software system for a satellite radio handheld computer accessory; and

FIG. 3 illustrates a block-flow diagram of a satellite radio handheld computer accessory algorithm.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

### Handheld Computer Systems as Software Platforms

A handheld computer system typically comprises hardware capable of executing machine-readable instructions, as well as software for executing acts typically as machine-readable instructions that produce a desired result. In addition, a handheld computer system may include hybrids of hardware and software, as well as computer sub-systems.

Software may be defined as machine code stored in memory, such as RAM or ROM, or machine code stored on devices (such as memory card, for example). Software may include executable code, an operating system, or source or object code, for example. In addition, software encompasses any set of instructions capable of being executed in a client machine or server—and, in this form, is often called a program or executable code.

Programs often execute in portions of code at a time. These portions of code are sometimes called modules or code-segments. Often, but not always, these code segments are identified by a particular function that they perform. For example, a counting module (or “counting code segment”) may monitor the value of a variable. Furthermore, the execution of a code segment or module is sometimes called an act. Accordingly, software may be used to perform a method that comprises acts. In the present discussion, sometimes acts are referred to as steps to help the reader more completely understand the exemplary embodiment.

Software also includes description code. Description code specifies variable values and uses these values to define attributes for a display, such as the placement and color of an item on a displayed page. For example, the Hypertext Transfer Protocol (HTTP) is the software used to enable the Internet and is a description software language.

Hybrids (combinations of software and hardware) are becoming more common as devices for providing enhanced functionality and performance to computer systems. A hybrid is created when traditionally software functions are directly manufactured into a silicon chip—this is possible since software may be assembled and compiled into ones and zeros, and, similarly, ones and zeros can be represented directly in silicon. Typically, the hybrid (manufactured hardware) functions are designed to operate seamlessly with software. Accordingly, it should be understood that hybrids and other combinations of hardware and software are also included within the definition of a computer system and are thus envisioned by the invention as possible equivalent structures and equivalent methods.

Handheld computer sub-systems are combinations of hardware or software (or hybrids) that perform some specific task. For example, one computer sub-system is a soundcard. For example, a soundcard provides hardware connections, memory, and hardware devices for enabling sounds to be produced and recorded by a handheld computer system. Likewise, a soundcard may also include software needed to enable a computer system to “see” the soundcard, recognize the soundcard, and drive the soundcard.

Methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### Description of the Drawings

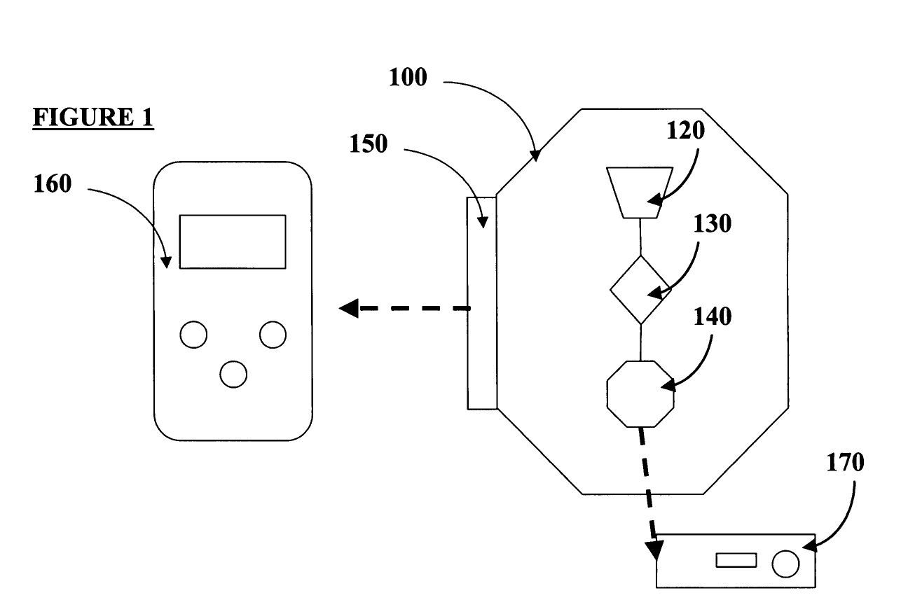

Reference is now made to the figures, and in particular with reference to FIG. 1, which generally depicts a satellite radio handheld computer accessory system. In one embodiment, the satellite radio handheld computer accessory system (the accessory system) comprises an apparatus known as a satellite radio handheld computer accessory 100 that is adapted to communicatively couple to a handheld computer 160, smart-phone, or similarly adaptable device. Upon reading the present invention disclosure, adaptations are readily apparent to those of skill in the handheld device arts. Common exemplary adaptations include bus interface ports such as PCMCIA ports, and USB ports, for example, and also includes wireless ports.

In general, the satellite radio handheld computer accessory (the accessory) 100 is adapted to communicate with a satellite via a satellite receiver 120 (which, by definition, is capable of receiving a satellite based signal), a satellite decoder 130 that functions as a means for converting a satellite based signal to a satellite data-element, and a compatible handheld computer bus interface (BI) 150 coupled to the satellite decoder 130. The satellite receiver is particularly adapted to receive satellite signals commonly known as “satellite radio” signals. The BI 150 may be any bus system used in any handheld computer, and is preferably a bi-directional bus such as Card Bus, PCMCIA, PCI, VME, ISA, SCSI, SDIO, or a wireless bus. Similarly, the BI 150 may be simulated via USB, Firewire, or NIC, for example.

Thus, it is seen that the accessory 100 is compatible with any type of computing device that has a compatible BI 150. Furthermore, the accessory 100 may include a transmitter logic 140 that produces signals comprising audio signal elements that may include factual data, process data, or code, as well as audio data. One embodiment of the transmitter logic 140 is as an FM transmitter logic system coupled to the satellite radio decoder 130. The FM radio logic system functions as a means for converting and transmitting satellite radio data-elements into FM radio waves that are receivable by an FM receiver 170. However, other transmitter logics are well known in the radio arts and are incorporated into the invention without departing from the scope of the invention. Further, although not shown in the figures since it is not necessary to understand the invention, memory may be included in the accessory 100, and such memory may store code and algorithms that provide functionality to the accessory 100. In one embodiment, upon docking, the code automatically downloads into handheld computer. Preferably, the code includes the algorithms and other functionality needed to control the accessory 100, such as “channel selection” features, volume, type of music, channel scanning, program previews, and other features offered by a satellite radio provider.

Although the satellite signals are described as “satellite radio” signals, this is a coined term that more accurately describes the primary nature of the reception destination equipment—audio (“radio”) reception. It is appreciated by those of skill in the art that the actual satellite signal may encompass any satellite signal, and is not limited to traditional “radio” or “satellite radio” signals, and any signal communication method known to those of skill in the satellite arts are encompassed within the ordinary meaning of the term “satellite radio” for purposes of the invention. In addition, it is also appreciated that the transmitter 140, although preferred in the present embodiment, is not limiting to the invention. For example, any means for sending a signal to an audio system may perform a similar function.

The FM transmitter logic may be adapted to transmit a satellite data-element to an FM receiver 170, such as that found in a car, a home audio system, or portable ‘boom box’, for example, on one or more carrier frequencies as is known in the art. In another embodiment, the FM transmitter logic is adapted to adjust the frequency of transmission of a satellite radio data element to a FM receiver 170 such that in addition to (or instead of) an audio signal, data information may be broadcast by the transmitter logic 140, which may then be displayed or processed by the receiver 170, and may be controlled by the handheld computer.

It will also be appreciated that the accessory 100 may be embodied on a component level, as a sub-component of a handheld computing device, as a chip-set or as a single chip, as is known to those of skill in the computer chip manufacturing arts.

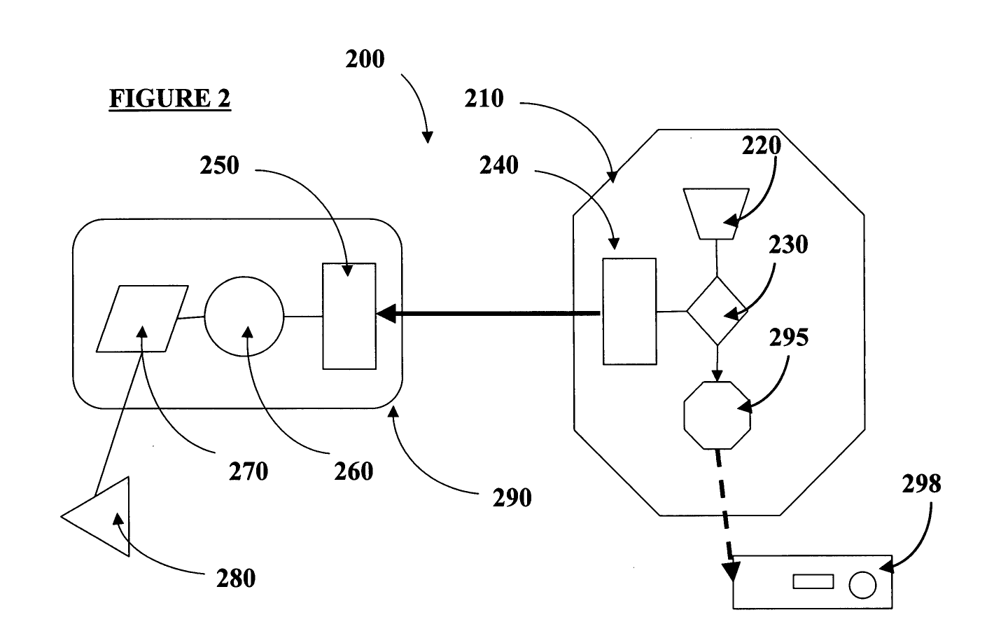

FIG. 2 show a software system 200 for a satellite radio handheld computer accessory 210. In one embodiment, the software system 200 includes front end logic 220 that receives and tracks a satellite based radio signal, decoder logic 230 that converts a satellite radio signal into a satellite radio data-element and transfers a satellite radio date-element from a handheld compatible BI having bus-interface logic 240 to a handheld computer BI logic 250 in a handheld computer system 290. In addition, in the preferred embodiment, the software system 200 for a satellite radio handheld computer accessory 210 includes an FM transmitter module 295 that is adapted to directing the broadcasting of satellite radio data to a nearby FM receiver 298.

In the preferred embodiment, the invention also incorporates software that executes on the handheld computer system 290. The handheld computer system 290 accordingly includes a handheld computer operating system 260, which may be imbedded, and which may be any common embedded or handheld operating system. Common operating systems include QNX RTOS, WindRiver VxWorks, Lineo Embeddix, Palm OS, Windows CE, Windows for Pocket PC, EPOC, and other Linux variants, for example (although the invention is not limited to any particular operating system). In a preferred embodiment, the handheld computer system 290 also includes an audio codec logic 270 or equivalent that is adapted to translate satellite radio data-elements between satellite radio signals and signals that are receivable by an audio device. The audio codec logic 270 may be integrated as a software component within the handheld computer operating system, embedded into an integrated circuit, or implemented in other ways known in the electronic arts. Further, the handheld computer comprises algorithms and functionality needed to control the accessory 100, such as “channel selection” features, volume, type of music, channel scanning, program previews, and other features offered by a satellite radio provider. Accordingly, in a preferred embodiment, the handheld computer provides active control to the accessory 100.

### Exemplary Methods

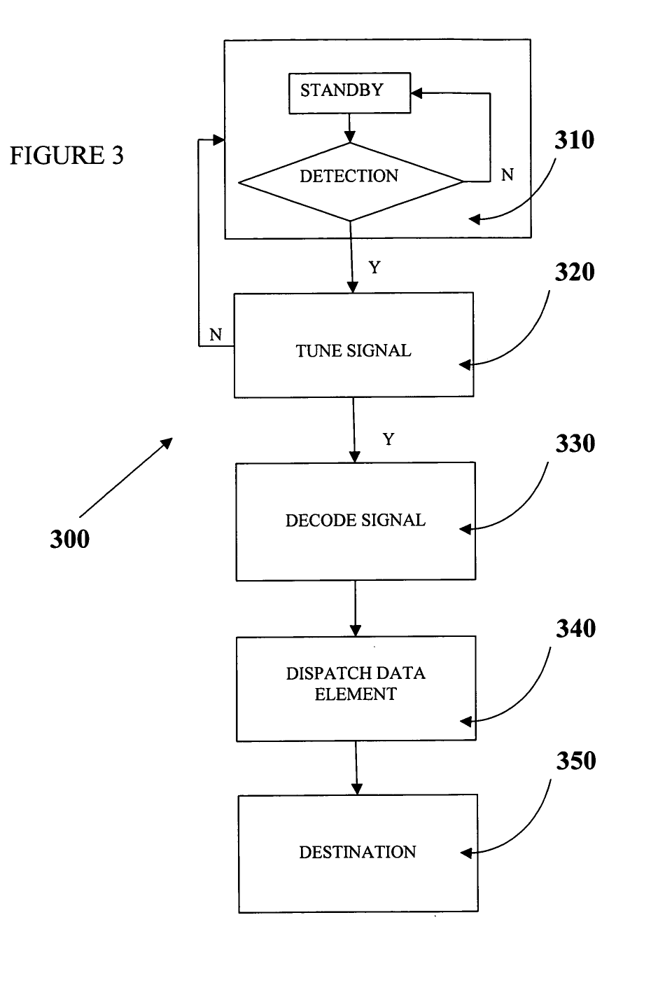

FIG. 3 illustrates a block-flow diagram of a Satellite Radio Handheld Computer Accessory (SRHCA) algorithm 300. In general, the SRHCA algorithm 300 detects, receives, decodes, and transmits data flow between the SRHCA and a handheld computer. As a method of transferring a satellite based data-element from a SRHCA to a handheld computer, the SRHCA algorithm 300 begins with a standby/detect signal act 310 in which the act periodically queries a satellite signal reception device such as the satellite signal receiver 120, in order to detect the presence of a satellite based signal. If no signal is detected, then the algorithm 300 returns to a standby state. Of course, other methods of standby/detection mode are known in the programming arts and these methods are likewise incorporated within the scope of the invention.

Next, in response to a signal being detected in the standby/detect act 310, the algorithm proceeds to a tune signal act 320. In the tune signal act 320, the algorithm 300 “tunes-in” the satellite based signal 320 to insure better/more accurate satellite reception. If the algorithm 300 is unable to tune the signal, the algorithm 300 returns to the standby/decode act 310. If the signal is successfully tuned in the tune signal act 320, in a decode signal act 330, the SRHCA algorithm 300 decodes the tuned satellite radio signal 320 and translates the signal into a satellite based data-element. The satellite based data-elements are then dispatched in a dispatch data element act 340. Although not part of the algorithm 300 except in so far as the algorithm co-exists in a handheld device, a destination act 350 indicates that the data-element has been received by a destination 350 which is a handheld device such as a handheld computer compatible bus logic, or a FM transmitter logic system, for example. Further, the algorithm 300 may comprise an act of controlling the accessory 100, which may comprise acts such as turning an accessory on/off, “channel selection” features, volume, type of music, channel scanning, program previews, and other features offered by a satellite radio provider.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. An apparatus, comprising:
a satellite receiver;
the satellite receiver adapted to receive a satellite signal;
a decoder;
the decoder coupled to the satellite receiver;
the decoder adapted to convert a satellite signal into a satellite data-element;
the satellite data-element comprising an audio signal element;
a handheld compatible bus interface; and
the handheld compatible bus interface coupled to the decoder.

2. The apparatus of claim 1 wherein the apparatus is embodied as a handheld computing device sub-component, and the apparatus is integrated into a handheld computing device.

3. The apparatus claim of 1 wherein the apparatus is communicatively coupled to a handheld computing device.

4. The apparatus claim of 1 further comprising a transmitter logic coupled to the decoder.

5. The system claim of 1 wherein the satellite radio receiver and decoder are integrated into a single chip.

6. The apparatus of claim 1 further comprising a transmitter logic coupled to the decoder, the transmitter logic adapted to transmit FM radio.

7. The apparatus of claim 1 further comprising a transmitter logic coupled to the decoder, the transmitter logic adapted to transmit a data element.

8. The apparatus of claim 1 further comprising memory coupled to the decoder, the memory storing a satellite radio handheld computer accessory algorithm.

9. The apparatus of claim 1 wherein the satellite receiver is a satellite radio receiver.

10. An apparatus, comprising:
a satellite receiver;
the satellite receiver adapted to receive a satellite signal;
a decoder;
the decoder coupled to the satellite receiver;
the decoder capable of converting a satellite based signal into a satellite data-element;
a handheld compatible bus interface;
the handheld compatible bus interface coupled to the decoder;
a transmitter logic; and
the transmitter logic coupled to the decoder.

11. The apparatus of claim 10 wherein the FM transmitter logic is adapted to broadcast a satellite data-element to an FM receiver.

12. The apparatus of claim 10 further comprising memory coupled to the decoder, the memory storing a satellite radio handheld computer accessory algorithm.

13. The apparatus of claim 10 wherein the satellite data-element comprises an audio signal element.

14. The apparatus of claim 10 wherein the satellite data-element comprises code.

15. A software system, comprising:
a front-end logic system;
the front end logic system adapted to receive a satellite based radio signal;
a decoder logic system;
the decoder logic system adapted to convert a satellite radio based signal into a satellite radio data-element; and
the decoder logic system also adapted to transfer the data-element to a handheld computer software system.

16. The software system of claim 15 further comprising a transmission logic system wherein the software system is adapted to transmit the satellite radio data-element.

17. A method comprising:
detecting a satellite signal at an apparatus;
automatically tuning the signal;
decoding the tuned signal to a satellite data-element;
the data-element comprising an audio signal element; and
dispatching the satellite data-element via a transmitter logic.

18. The method of claim 17 further comprising receiving a tuning command from a handheld computing device.

19. The method of claim 17 further comprising verifying that the receiver is registered with a satellite radio service.

20. The method of claim 17 wherein the apparatus comprises:
a satellite receiver;
the satellite receiver adapted to receive a satellite signal;
a decoder coupled to the satellite receiver;
the decoder adapted to convert a satellite signal into a satellite data-element;
the satellite data-element comprising an audio signal element;
a handheld compatible bus interface; and
the handheld compatible bus interface coupled to the decoder.
